(19) United States
(12) Patent Application Publication
(10) Pub. No.: US 2007/0298240 A1
(43) Pub. Date: Dec. 27, 2007

(54) COMPRESSIBLE ABRASIVE ARTICLE

(76) Inventors: Feben T. Gobena, New Brighton, MN (US); William D. Joseph, Maplewood, MN (US)

Correspondence Address: 3M INNOVATIVE PROPERTIES COMPANY, PO BOX 33427, ST. PAUL, MN, 55133-3427, US

(21) Appl. No.: 11/425,963

(22) Filed: Jun. 22, 2006

(51) Int. Cl. B32B 5/16; B32B 27/00; B32B 27/04; C09K 3/14; B32B 33/00

(52) U.S. Cl. 428/323; 428/35.7; 428/413; 428/423.1; 428/480; 51/298

(57) ABSTRACT

Abrasive articles having a compressible composite layer are described. The compressible composite layers include a compressible binder and abrasive agglomerates. Methods of using such abrasive articles to modify the edge of a workpiece are also described.

### FIELD

This disclosure pertains to abrasive articles having a compressible composite layer that includes a compressible binder and abrasive agglomerates. Methods of using such abrasive articles to modify the edge of a workpiece are also disclosed.

### BACKGROUND

Rigid cylindrical discs are common intermediates in a variety of commercial enterprises. For example, in the manufacture of semiconductor devices, silicon wafers are obtained by slicing a solid cylindrical ingot.

Generally, the peripheral edges of the cylindrical discs may have defects including small sub-surface cracks or chips. These defects can create problems in subsequent processing steps, e.g., some defects can propagate from the peripheral edge to the interior of the disc. In addition, as initially produced, cylindrical discs may have sharp edges that are prone to chipping and can be hazardous to handle. Also, after one or more processing steps, undesirable debris may be present at or near the edge of the disc.

Various types of grinding machines have been used to modify such peripheral edges to minimize or eliminate defects and to round, bevel, or otherwise contour sharp edges. Grinding has been conducted using both grinding wheels comprising abrasive particles fixed in a metal or resin matrix, and fixed abrasive webs comprising abrasive particles fixed in a matrix and adhered to a flexible backing. In addition, polishing slurries have been used wherein the edge of the disc contacts a polishing pad in the presence of a slurry of abrasive particles in a liquid medium.

### SUMMARY

In one aspect, the present disclosure provides an abrasive article comprising a compressible composite layer comprising a compressible binder and abrasive agglomerates. In some embodiments, the compressible composite layer comprises about 2% to about 10% by volume abrasive agglomerates. In some embodiments, the compressible composite layer has a compression modulus of about 7 to about 70 GPa.

In some embodiments, the compressible composite layer comprises at least 50% by volume of the compressible binder. In some embodiments, the compressible binder comprises a material selected from the group consisting of urethanes, polyether urethanes, polyester urethanes, epoxies, and combinations thereof. In some embodiments, the composite layer further comprises an inorganic filler.

In some embodiments, the abrasive agglomerates have a density of about 2.45 to about 2.75 grams per cubic centimeter (g/cc). In some embodiments, the abrasive agglomerates have a density of about 2.15 to about 2.35 g/cc. In some embodiments, the average maximum cross-sectional dimension of the diamond abrasive particles is less than about 2 microns.

In some embodiments, the abrasive agglomerates comprise abrasive particles dispersed in an inorganic matrix. In some embodiments, the inorganic matrix is selected from the group consisting of glass, ceramic, and glass ceramic. In some embodiments, the inorganic matrix comprises silica.

In some embodiments, the abrasive agglomerates comprise diamond abrasive particles. In some embodiments, the agglomerates comprise 25% to 50% by weight diamond abrasive particles. In some embodiments, the abrasive agglomerates comprise about 0.1% to about 50% by weight alumina abrasive particles. In some embodiments, e.g., embodiments wherein the article is used for cleaning, the abrasive agglomerates comprise at least about 95%, 99%, or even 100% by weight inorganic matrix, e.g., silica.

In another aspect, the abrasive article further comprises a support adjacent the composite layer. In some embodiments, the composite layer is directly bonded to the support. In some embodiments, a bonding layer is interspersed between the composite layer and the support. In some embodiments, the support is selected from the group consisting of a rigid cylinder, a rigid ring, and a flexible web. In some embodiments, the flexible web is a continuous belt. In some embodiments, the support is a rigid planar body.

In another aspect, the present disclosure provides a method of modifying an edge of a disc. In some embodiments, the method comprises providing an abrasive article comprising a compressible composite layer, wherein the compressible composite layer comprises a compressible binder and abrasive agglomerates; contacting the edge of the disc with a major surface of the compressible composite layer; and providing a relative motion between the edge of the disc and the major surface of the compressible composite layer. In some embodiments, contacting the edge of the disc with the major surface of the compressible composite layer comprises applying sufficient contact force to compress the compressible composite layer by about 2.5% to about 5.5%. In some embodiments, the contact force is in the range of about 1.5 to about 8 kilograms per millimeter of thickness of the disc. In some embodiments, the velocity of the major surface of the composite layer relative to the edge of the disc is between about 8 and about 16 meters per second, inclusive.

In some embodiments, creating a relative motion between the edge of the disc and the major surface of the composite layer comprises rotating the disc about a first axis of rotation and rotating the abrasive article around a second axis of rotation. In some embodiments, the first axis of rotation forms an angle of between about 5 degrees and about 75 degrees with the second axis of rotation.

In some embodiments, the method of modifying an edge of a disc further comprises applying a working fluid to the major surface of the composite layer.

The details of one or more embodiments of the disclosure are set forth in the description below. Other features, objects, and advantages will be apparent from the description and from the claims.

### BRIEF DESCRIPTION OF THE DRAWINGS

FIG. 1 illustrates an exemplary abrasive article according to some embodiments of the present disclosure.

FIG. 2 illustrates an exemplary abrasive agglomerate according to some embodiments of the present disclosure.

FIG. 3a illustrates one embodiment of the modification of the edge of disc according to the present disclosure.

FIG. 3b illustrates the compression of an abrasive article during the modification of the edge of a disc as shown in FIG. 3a.

FIG. 4a illustrates another embodiment of the modification of the edge of disc according to the present disclosure.

FIG. 4b illustrates the compression of an abrasive article during the modification of the edge of a disc as shown in FIG. 4a.

FIG. 5 illustrates the edge modifying apparatus used in Test Method A.

### DETAILED DESCRIPTION

In some embodiments, abrasive articles of the present disclosure may be useful to modify the peripheral edge of a workpiece (e.g., a disc, e.g., a rigid cylindrical disc). In some embodiments, modifying comprises altering the profile of the edge of a workpiece, e.g., to minimize or eliminate defects and/or to round, bevel, or otherwise contour sharp edges. In some embodiments, modifying comprises cleaning (e.g., removing debris from) the edge of a workpiece. In some embodiments, the workpiece may be a silicon wafer obtained, e.g., by slicing a solid cylindrical ingot. Other useful workpiece materials include glass, glass ceramics, ceramics, gallium arsenide, sapphire, and compound semiconductor substrates.

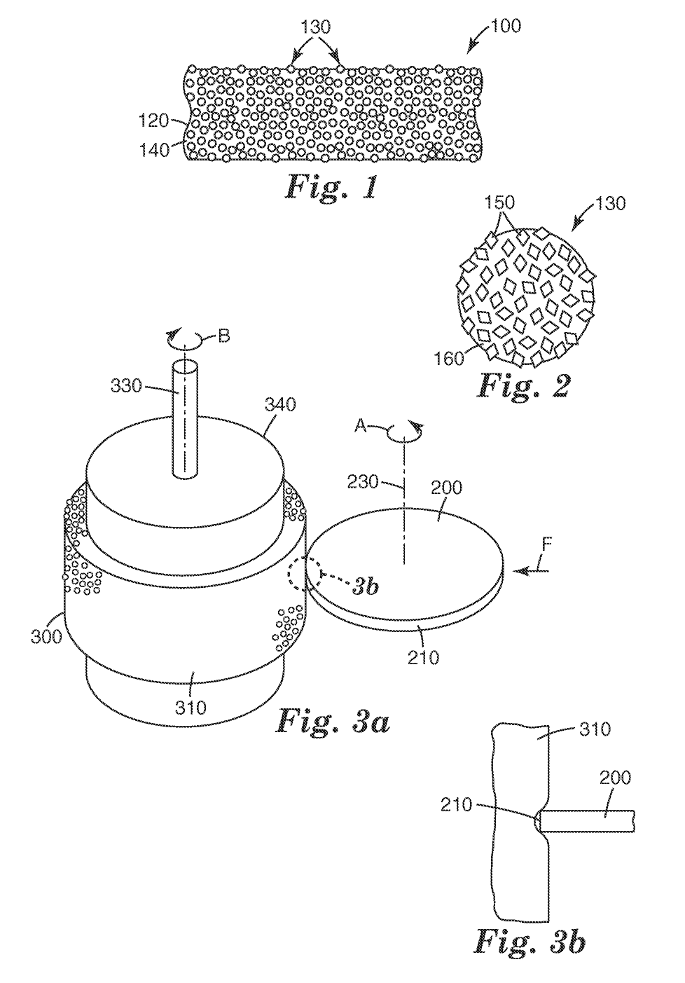

Exemplary abrasive article 100 according to some embodiments of the present disclosure is shown in FIG. 1. Abrasive article 100 includes composite layer 120 comprising abrasive agglomerates 130 dispersed in binder 140. In contrast to the composite layers associated with typical abrasive articles, the composite layers of the present disclosure are readily compressible under typical operating conditions (e.g., applied loads). The compressibility of a material can be described using parameters such as compression modulus and compression set.

Compression modulus is defined as the ratio of the compressive stress to the compressive strain in a material. Compression modulus can be measure by applying a fixed compressive stress (i.e., load per unit area) to a material and measuring the reduction in the material's thickness. The load per unit area is then incrementally increased, and the reduction in thickness is measured for each increment in load.

The strain in the material, defined as the reduction in thickness divided by the initial thickness (i.e., the thickness with no applied load), can be calculated for each applied load; i.e.,

$${S}_{L} = \frac{( {T}_{i} - {T}_{L} )}{{T}_{i}} ;$$

wherein S_{L} is the strain at applied load L, T_{L} is the thickness at applied load L, and Tᵢ is the initial, or unloaded, thickness. Note that the percent compression (PC) at load L is simply 100 times the strain at load L; i.e.,

$$PC = 100 \times ( \frac{{T}_{i} - {T}_{L}}{{T}_{i}} ) .$$

The applied load can then be plotted against the strain. The compression modulus is the slope of this curve, i.e., the change in applied load divided by the change in strain over the range of strain of interest.

Generally, the desired degree of compression of the compressible layer (i.e., the range of strain of interest) will depend on the composition, thickness, and strength of the workpiece being modified. In addition, the desired modification (e.g., rounding or beveling) and the angular relationship between the edge of the workpiece and the surface of the compressible layer may also affect the desired degree of compression.

In some embodiments, the composite layers of the present disclosure are compressed from about 2.5% to about 5.5%. In some embodiments, the compression of the composite layer is at least about 3%. In some embodiments, the compression of the composite layer is no greater than about 4%.

In some embodiments, the compression modulus of the composite layer is between about 7 GPa and about 70 GPa over the range of about 2.5% to about 5.5% compression. In some embodiments, a compression modulus below about 7 GPa can result in a reduction in removal rates. In some embodiments, if the compression modulus is above about 70 GPa the workpiece pressed against the composite layer may shatter, and/or uniform edge modifying action may not be achieved. In some embodiments, the compression modulus is at least about 20 GPa, or even at least about 30 GPa over the range of about 2.5% to about 5.5% compression. In some embodiments, the compression modulus is no greater than about 55 GPa over the range of about 2.5% to about 5.5% compression.

In some embodiments, the composite layers of the present disclosure are elastically compressible and, thus, have low compression set. Compression set (CS) is defined as:

$$CS = 100 \times ( \frac{{T}_{i} - {T}_{f}}{{T}_{i} - {T}_{L}} ) ;$$

wherein T_{f} is the thickness of the material after the compressive load has been removed. In some embodiments, the compressible layer of the present disclosure has a compression set of less than about 50%, in some embodiments, less than about 25%, in some embodiments, less than about 10%, or even less than about 5%. Generally, if the compression set is too high, the compressible layer will not exhibit the desired level of compression modulus over the desired range of compression during second and subsequent compression cycles.

Generally, the compression properties of the composite layer are affected by the compression properties of the binder and the type and amount of agglomerate included in the composite layer. The presence of fillers may also affect compression properties. For example, in some embodiments, an increase in the volume or weight percent of abrasive agglomerates and/or fillers present in the binder of the composite layer will increase the compression modulus of the composite layer relative to the compression modulus of the unfilled binder.

In some embodiments, the composite layer comprises at least about 50% by volume binder. In some embodiments, the composite layer comprises at least about 60%, in some embodiments, at least about 75%, and even at least about 90% by volume binder.

Exemplary binders include polyurethanes (e.g., polyether polyurethanes and polyester urethanes) and epoxies. In some embodiments, the compression modulus of the binder is at least about 5 GPa, in some embodiments, at least about 10 GPa, or even at least about 20 GPa, over the range of about 2.5% to about 5.5% compression. In some embodiments, the compression modulus of the binder is no greater than about 40 GPa, in some embodiments, no greater than about 30 GPa, or even no greater than about 25 GPa, over the range of about 2.5% to about 5.5% compression. In some embodiments, the binder has a compression modulus of about 10 to about 30 GPa over the range of about 2.5% to about 5.5% compression.

Generally, the use of abrasive agglomerates in an abrasive article results in higher and more consistent cut-rates, as well as a longer useful life, relative to a similar abrasive article using abrasive particles alone. These advantages are typically observed despite little or no decrease in the fineness of the surface finish.

In some embodiments, the composite layer comprises about 2% to about 10% by volume abrasive agglomerates. Below about 2% by volume abrasive agglomerates a reduced rate of edge modification, e.g., edge polishing, can occur in some embodiments; while in some embodiments having above about 10% by volume abrasive agglomerates, the resulting composite layer may be too rigid, which can result in damage to the workpiece (e.g., shattering) and/or non-uniform edge modification action. In some embodiments, the composite layer comprises no greater than 6%, in some embodiments, no greater than 4%, or even no greater than about 3% by volume abrasive agglomerates. In some embodiments, the composite layer comprises at least about 2.5% by volume abrasive agglomerates.

In some embodiments, the composite layer comprises materials in addition to the binder and the abrasive agglomerates. In some embodiments, the composite layer includes one or more inorganic fillers. Exemplary inorganic fillers include silica, clay, glass beads (e.g., hollow glass beads), and combinations thereof.

In some embodiments, abrasive agglomerates comprise abrasive particles dispersed in an inorganic matrix. The inorganic matrix may be crystalline, semi-crystalline, or amorphous. Exemplary inorganic matrices include glass, ceramic, and glass-ceramic materials. In some embodiments, the inorganic matrix comprises silica.

Referring to FIG. 2, exemplary abrasive agglomerate 130 comprises abrasive particles 150 dispersed in matrix 160. The abrasive agglomerates may be irregularly shaped or may have a predetermined shape, e.g., spherical abrasive agglomerates. Exemplary abrasive agglomerates are further described in U.S. Pat. Nos. 4,652,275; 4,799,939; and 5,500,273.

Generally, any known abrasive particle may be used. Exemplary abrasive particles include diamonds, silicon carbide, alumina, and boron nitride particles. In addition, Bruxvoort et al. in U.S. Pat. No. 5,958,764 (column 18, line 16 through column 21, line 25 of which is incorporated herein by reference) describe useful abrasive particles. In some embodiments, diamond abrasive particles are preferred.

In some embodiments, the agglomerates comprise about 25% to about 50% by weight abrasive particles, e.g., diamond abrasive particles. Below about 25% by weight abrasive particles the agglomerates may yield low levels of edge modifying action in some embodiments. In some embodiments wherein the agglomerates contain above about 50% by weight abrasive particles, the agglomerates may tend to release the abrasive particles during use, which can result in unstable modification rates. In some embodiments, the agglomerates comprise at least about 30%, and in some embodiments, at least about 35%, by weight abrasive particles. In some embodiments, the agglomerates comprise no greater than about 45%, and in some embodiments no greater than about 40%, by weight abrasive particles.

In some embodiments, the abrasive particles include alumina abrasive particles. In some embodiments, the abrasive agglomerates include at least about 0.1% by weight, in some embodiments, at least about 1% by weight, or even at least about 5% by weight alumina abrasive particles. In some embodiments, the abrasive agglomerates comprise no more than about 50% by weight, in some embodiments no more than about 40% by weight, or even no more than about 30% by weight alumina abrasive particles.

In some embodiments, e.g., when workpiece cleaning rather than edge modification is desired, the abrasive agglomerates may contain few, if any abrasive particles. In some embodiments, the abrasive agglomerates may consist essentially of the inorganic matrix material, e.g., silica. In some embodiments, the agglomerates comprise at least about 95% silica, e.g., at least about 98% silica, or even 100% silica.

Generally, the maximum cross-sectional dimension of an abrasive particle is a conventional measure of the size of a particle, while the average maximum cross-sectional dimension is a conventional parameter used to describe a collection of abrasive particles. In some embodiments of the present disclosure, the average maximum cross-sectional dimension of the abrasive particles is less than about 2 microns, in some embodiments, less than about 1 micron, or even less than about 0.5 microns. Generally, the smaller the average maximum cross-sectional dimension of the abrasive particles, the finer the resulting surface finish.

In some embodiments, the abrasive agglomerates have a density of about 2.45 to about 2.75 grams per cubic centimeter (g/cc). In some embodiments, the density is no greater than about 2.65 g/cc, or even no greater than about 2.55 g/cc. In some embodiments, the abrasive agglomerates have a density of about 2.15 to about 2.35 g/cc. In some embodiments, the density is at least about 2.20 g/cc. In some embodiments, the density is no greater than about 2.30 g/cc.

In some embodiments, abrasive articles of the present disclosure include a support adjacent the composite layer. The support may be rigid or flexible. In some embodiments, the support may include a compressible layer, e.g., foam. However, the abrasive articles of the present disclosure, which include a compressible composite layer, are distinguishable from abrasive articles having an incompressible composite layer and a compressible support. For example, in some embodiments, the composite layer itself conforms to the shape of edge of the workpiece edge during the modification process.

Exemplary materials useful for constructing supports include metals (e.g., stainless steel, nickel, brass, copper and iron), polymers (e.g., polyesters, polyolefins, polyimides, nylons and polyurethanes), polymeric films, and woven or non-woven webs. In addition, Bruxvoort et al. in U.S. Pat. No. 5,958,764 (column 17, line 12 through column 18, line 15 of which is incorporated herein by reference) describe useful supports. Particular selection is within the skill in the art.

The support can take on any known shape. In some embodiments, the support is a rigid cylinder. In some embodiments, the support is a rigid ring. In some embodiments, the support is a flexible web. In some embodiments the flexible web is continuous belt. In some embodiments, the support is a rigid planar body, e.g., a flat disc.

In some embodiments, the composite layer is bonded directly to a major surface of the support. In some embodiments, a bonding layer, e.g., a primer layer and/or an adhesive layer may be interposed between the composite layer and a major surface of the support. Additional layers such as reinforcing scrims may also be present. Generally, selection of appropriate primers and/or adhesives is within the abilities of one of ordinary skill in the art. Exemplary adhesives include pressure sensitive adhesives and heat activatable adhesives.

Generally, the abrasive articles of the present disclosure can be used in any known polishing operation, either with or without the support. For example, in some embodiments, the abrasive articles can be used to polish, contour, and/or clean the edge of a workpiece. The workpiece may be a rigid disc, e.g., a wafer. The workpiece can be made of any known material including, e.g., glass, ceramic, silicon, gallium arsenide, sapphire, metal, e.g., copper, or combinations thereof. In some embodiments, the workpiece comprises two or more layers composed of the same or different materials.

Generally, the peripheral edge of the workpiece is brought into contact with a major surface of the composite layer. In some embodiments, the edge is brought into contact with the composite layer using sufficient force to compress the composite layer.

The modification of edge 210 of disc 200 according to one embodiment of the present disclosure is shown in FIGS. 3a and 3b. Referring to FIG. 3a, edge 210 contacts composite layer 310 of abrasive article 300, which is mounted on abrasive article support 340. A relative rotational motion is created between the edge of the disc and the composite layer. Edge 210 of disc 200 contacts composite layer 310 such that disc 200 is substantially perpendicular to the surface of composite layer 310. In this orientation, disc axis of rotation 230 is substantially parallel to abrasive article axis of rotation 330. Generally, contact force F is applied to urge the edge of the plate into the compressible composite layer (see FIG. 3b).

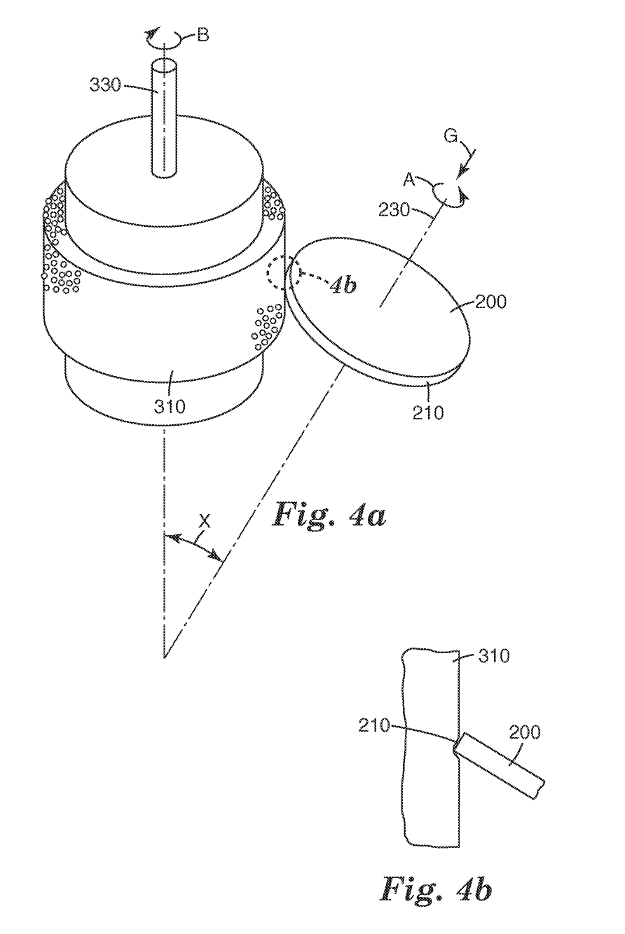

The modification of edge 210 of disc 200 according to another embodiment of the present disclosure is shown in FIG. 4a. Referring to FIG. 4a, edge 210 of disc 200 contacts composite layer 310 such that disc axis of rotation 230 forms an angle X relative to abrasive article axis of rotation 330. Generally, the angle between the axis of rotation can vary from 0 degrees (i.e., parallel) to 89 degrees. In some embodiments, the angle is between about 5 degrees and 75 degrees. In some embodiments, the angle is at least about 5 degrees, in some embodiments, at least about 30 degrees, or even at least about 40 degrees. In some embodiments, the angle is no greater than about 75 degrees, in some embodiments, no greater than about 60 degrees, or even no greater than about 50 degrees. Generally, contact force G is applied to urge the edge of the plate into the compressible composite layer (see FIG. 4b).

Referring to FIGS. 3b and 4b, generally, the contact force is sufficient to compress composite layer 310 such that it at least partially conforms to the profile of edge 210 of disc 200. In some embodiments, the composite layer is compressed at least about 5% of the thickness of the disc, in some embodiments, at least about 15%, or even at least about 25%. In some embodiments, the composite layer is compressed no greater than about 100% of the thickness of the disc, in some embodiments, no greater than about 60%, or even no greater than about 50%. In some embodiments, the composite layer is compressed between about 20% and about 30% of the thickness of the disc. In some embodiments, composite layer is compressed between about 40% and about 50% of the thickness of the disc.

Generally, the contact force required to achieve the desired degree of compression of the composite layer should be high enough to achieve the desired degree of uniform edge modification. However, the contact force required to achieve the desired degree of compression of the composite layer should be low enough to minimize or prevent damage to the composite layer and/or the workpiece. The desired contact force will depend on the compression modulus of the compressible layer, the thickness and material of the workpiece being modified, the process time, and the angle at which the edge of the workpiece makes contact with the surface of the compressible layer.

In some embodiments, the applied contact force is in the range of 1.5 to 8 kilograms per millimeter of thickness of the workpiece (kg/mm), although, with appropriate selection of the compressible layer and the workpiece, values outside this range may be suitable as well. In some embodiments, the contact force is at least about 2 kg/mm, and, in some embodiments, at least about 3 kg/mm. In some embodiments, the contact force is no greater than about 6 kg/mm, and in some embodiments, no greater than about 4 kg/mm.

In some embodiments, applied forces of less than 1.5 kg/mm may result in uneven and/or insufficient modification of the workpiece edge. In some embodiments, applied forces of greater than 8 kg/mm may cause the workpiece to fracture. In some embodiments, applied forces of greater than 6 kg/mm may cause the workpiece edge to cut into the composite layer.

In order to modify the edge of a workpiece, a relative rotational motion is created between the edge of the workpiece and the composite layer. Referring to FIGS. 3a and 4a, in some embodiments, a disc may be rotated relative to the composite layer as shown by arrow A. In some embodiments, the abrasive article may be rotated relative to the edge of the disc. For example, in some embodiments, the composite layer is adjacent a support, e.g., cylindrical support 350, and the support and abrasive article are rotated relative to the edge of the disc, as shown by arrow B. In FIGS. 3a and 3b, the disc and the composite layer are counter-rotating. In some embodiments, the disc and the composite layer may be co-rotating.

Regardless of whether the abrasive article is moving, the disc is moving, or both are moving, it is often desirable to control the relative velocity between the abrasive article and the edge of the disc. In some embodiments, the relative velocity is between about 8 and about 16 meters per second (m/s). In some embodiments the relative velocity is at least about 10 m/s and, in some embodiments, at least about 12 m/s. In some embodiments, the relative velocity is no greater than about 15 m/s.

In some embodiments, the relative rotational motion between the edge of the disc and the composite layer while they are forced into contact may result in undesirable wear patterns in the composite layer. For example, a groove corresponding to the dimensions of the disc edge may be worn into the composite layer.

In some embodiments, the abrasive article and/or the workpiece may be moved parallel to the abrasive article axis of rotation during the modifying process. For example, in some embodiments, the abrasive article may be oscillated such that a component of the linear oscillation velocity is perpendicular to the edge of the disc. In some embodiments, the edge of the disc maybe oscillated relative to the surface of the abrasive article. In some embodiments, the linear oscillation may be controlled such that the relative linear motion between abrasive article and the edge of the disc occurs at a substantially constant velocity.

In some embodiments, modification of the edge of a workpiece may be conducted in the presence of a working fluid in contact with the workpiece and the abrasive article. In some embodiments, the working fluid is chosen based on the properties (e.g., composition, etc.) of the workpiece to provide the desired modification without adversely affecting or damaging the workpiece. In some embodiments, the working fluid may contribute to processing, in combination with the fixed abrasive article, through a chemical mechanical polishing process.

During the processing of some workpieces, it is preferred that the working fluid is an aqueous solution that includes a chemical etchant such as an oxidizing material or agent. In some embodiments, the working fluid contains one or more complexing agents, e.g., monodentate complexing agents and/or multidentate complexing agents. In some embodiments, amino acids, including, e.g., alpha-amino acids (e.g., L-proline, glycine, alanine, arginine, and lysine), may be used. In some embodiments, the pH of the liquid medium may affect performance, and is selected based upon the nature of the substrate being modified. In some embodiments, buffers may be added to the working fluid to control the pH and thus mitigate pH changes from minor dilution from rinse water and/or differences in the pH of the deionized water depending on the source. In some embodiments, the working fluid may contain additives such as surfactants, wetting agents, rust inhibitors, lubricants, soaps, and the like. A lubricant, for example, may be included in the working fluid for the purpose of reducing friction between the abrasive article and the workpiece during processing.

After modification of the edge of the workpiece is complete, the workpiece can be further processed as desired using procedures known in the art.

The following specific, but non-limiting, examples will serve to illustrate the invention. In these examples, all percentages are parts by weight unless otherwise indicated.

### Test Methods

### Test Method A—Edge Polishing

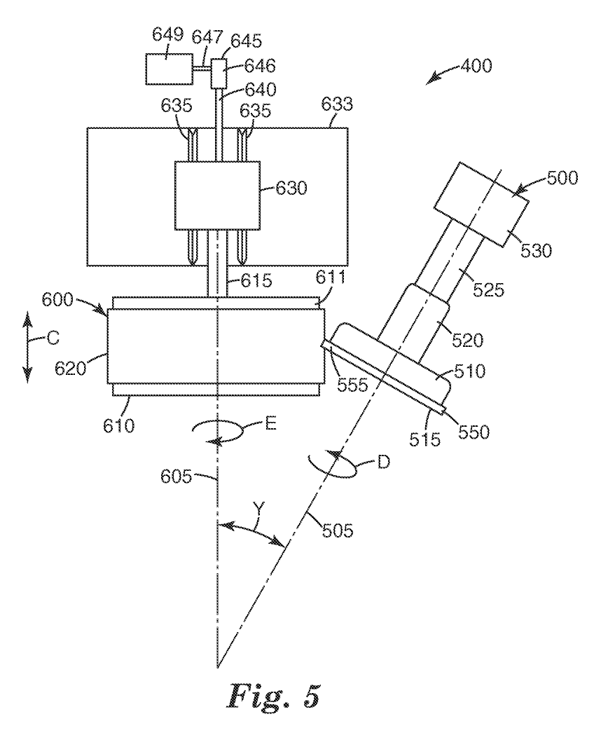

Tests were performed on the edge modifying apparatus shown in FIG. 5. Referring to FIG. 5, edge modifying apparatus 400 includes disc holding unit 500, and disc edge modifying unit 600.

Disc-holding unit 500 includes vacuum disc chuck 510 having disc-mounting surface 515. Disc 550 is releasably held against the disc-mounting surface by creating a vacuum at the disc-mounting surface sufficient to hold the disc in place during the edge modifying operation. Disc-holding unit 500 includes positioning assembly 520. The positioning assembly is used to bring edge 555 of disc 550 in contact with abrasive article 620 and to apply the desired contact force between the edge of the disc and the surface of the abrasive article.

Disc-holding unit 500 also includes drive shaft 525 mechanically coupled to motor 530. Motor 530 rotates drive shaft 525, and ultimately disc chuck 510 and disc 550 about disc chuck axis of rotation 505, as shown by arrow D. Edge-modifying unit 600 includes abrasive article support 610 mechanically coupled to drive shaft 615, which is mechanically coupled to motor 630. Motor 630 rotates drive shaft 615 and ultimately abrasive article support 610 about support axis of rotation 605, as shown by arrow E.

The abrasive article support and the disc are counter-rotating. As shown in FIG. 5, co-planar disc chuck axis of rotation 505 and support axis of rotation 605 intersect forming angle Y. In each of the examples, angle Y was 45 degrees.

Referring to FIG. 5, motor 630 is shown mounted to frame 633 on tracks 635. Motor 630 is mechanically coupled to cam follower 640, which is mechanically coupled to peripheral edge 646 of cam 645. Cam shaft 647 mechanically couples cam 645 to motor 649. As motor 649 rotates cam 645 via cam shaft 647, cam follower 640 tracks peripheral edge 646 of cam 645. Cam follower 640 translates the rotational motion of cam 645 into a linear motion, which ultimately results in the linear oscillation of abrasive article support 610 and abrasive article 620 relative to disc 550 (as shown by arrow C).

A cam was created to deliver a substantially constant oscillation velocity across the abrasive article. To design such a cam, the traverse distance and the minimum radius of the cam compatible with the mechanical components of the cam drive and the cam follower were determined. The desired radius as a function of angle was then generated, and the polar coordinates were converted to x-y coordinates, as shown in Table 1 for a cam having a minimum radius of 6.4 millimeters (mm) (0.25 inches), and a maximum radius of 57.2 mm (2.25 inches).

The x-y coordinates provided in Table 1 were entered into an AutoCad LT drawing program which generated the shape of cam using a spline function. The spline fit rounded the cam shape at 0 and 180 degrees. The resulting full size drawing produced by the AutoCad LT program was printed out, adhered to a piece of sheet metal, and cut out with a band saw following the line of the drawing to produce a heart-shaped cam.

TABLE 1
Radius as a function of angle for a cam generating a substantially constant
oscillation velocity.

| | millimeters | | |
|---|---|---|---|
| angle | radius | x | y |
| 0 | 6.4 | 6.4 | 0.0 |
| 10 | 9.2 | 9.0 | 1.6 |
| 20 | 12.0 | 11.3 | 4.1 |
| 30 | 14.8 | 12.8 | 7.4 |
| 40 | 17.6 | 13.5 | 11.3 |
| 50 | 20.5 | 13.2 | 15.7 |
| 60 | 23.3 | 11.6 | 20.2 |
| 70 | 26.1 | 8.9 | 24.5 |
| 80 | 28.9 | 5.0 | 28.5 |
| 90 | 31.8 | 0.0 | 31.8 |
| 100 | 34.6 | −6.0 | 34.0 |
| 110 | 37.4 | −12.8 | 35.1 |
| 120 | 40.2 | −20.1 | 34.8 |
| 130 | 43.0 | −27.7 | 33.0 |
| 140 | 45.9 | −35.1 | 29.5 |
| 150 | 48.7 | −42.2 | 24.3 |
| 160 | 51.5 | −48.4 | 17.6 |
| 170 | 54.3 | −53.5 | 9.4 |
| 180 | 57.2 | −57.2 | 0.0 |
| 190 | 54.3 | −53.5 | −9.4 |
| 200 | 51.5 | −48.4 | −17.6 |
| 210 | 48.7 | −42.2 | −24.3 |
| 220 | 45.9 | −35.1 | −29.5 |
| 230 | 43.0 | −27.7 | −33.0 |
| 240 | 40.2 | −20.1 | −34.8 |
| 250 | 37.4 | −12.8 | −35.1 |
| 260 | 34.6 | −6.0 | −34.0 |
| 270 | 31.8 | 0.0 | −31.8 |
| 280 | 28.9 | 5.0 | −28.5 |
| 290 | 26.1 | 8.9 | −24.5 |
| 300 | 23.3 | 11.6 | −20.2 |
| 310 | 20.5 | 13.2 | −15.7 |
| 320 | 17.6 | 13.5 | −11.3 |
| 330 | 14.8 | 12.8 | −7.4 |
| 340 | 12.0 | 11.3 | −4.1 |
| 350 | 9.2 | 9.0 | −1.6 |
| 360 | 6.4 | 6.4 | 0.0 |

A 7.62 cm (3.0 inch) wide flexible abrasive article was mounted to a 35.6 cm (14 inch) diameter by 8.9 cm (3.5 inch) wide drum (i.e., abrasive article support 610) using a pressure sensitive adhesive. In a first conditioning step, the flexible abrasive article was wet with deionized water and the drum was rotated at 700 rpm while holding 268XA A35 abrasive (obtained from 3M Company, Maplewood, Minn.) mounted to a 5 cm (2 inch) diameter by 15.25 cm (6 inch) long metal rod in contact with the flexible abrasive article for one minute. After this first conditioning step, the flexible abrasive article was wiped with isopropyl alcohol. A second conditioning step was conducted using a 268XA A10 abrasive-covered rod for one minute followed by wiping with isopropyl alcohol. The 268XA A10 abrasive was obtained from 3M Company, Maplewood, Minn.

A 200 mm diameter silicon wafer (obtained from MEMC Corporation, St. Peters, Mo.) polished to an 800 micron final thickness was held by the vacuum disc chuck and rotated at 2 rpm while the drum was rotated at 900 rpm. Deionized water was dispensed at 30 mL/min and the force applied through the pneumatic cylinder was set to 3.63 Kg (8 lbs) unless noted otherwise. Cut rates were measured by noting the total mass removed from a wafer after 15 minutes.

### Test Method B—Compression and Compression Set

The percent compression and percent compression set were measured by placing a 2.54 cm diameter piece of a flexible abrasive on a flat granite piece. A load of 4.35 Kg was applied for 30 seconds via a circular fixture that had an area of 1.27 square centimeters. The percentage compression was recorded at the end of 30 seconds. The compression set was calculated as 100% minus the percentage of initial caliper recovered 30 seconds after the applied load was removed was recorded.

### Test Method C—Compression Modulus

Compression modulus was measured according to ASTM Test Method D695 with the following modifications. A sample with a diameter of 20 mm and a thickness of 1.0 mm was placed between the top and bottom surfaces of a compression fixture (MTS Q-TEST electromechanical testing frame interfaced with TESTWORKS 4 software). The bottom surface was held stationary while the top surface was lowered at a speed of 0.25 mm/min. A peak load of 200 kilograms was applied. The load was measured with a 500 kilogram compression load cell. Displacement data were directly acquired from the data acquisition software (MTS TESTWORKS 4). The load-displacement curve for each test was converted to a stress-strain curve, wherein the stress was the load divided by the original area of the specimen, and the strain was the displacement divided by the original height of the specimen. The compression modulus was extracted from the stress strain curve.

### Method of Preparing Compressible Abrasive Articles

The materials used in the following examples are summarized in Table 2.

TABLE 2
Summary of materials used and sources

| | | |
|---|---|---|
| | 0.5 micron diamonds | Tomel Corp. of America, Cedar Park, TX |
| | 0.25 micron diamonds | Tomel Corp. of America, Cedar Park, TX |
| Z-6020 | Silane | Dow Corning Corporation, Midland, MI |
| ARCOL PPG-2025 | Polyether glycol | Bayer AG, Leverkusen, Germany |
| LHT-112 | Polyether glycol | Bayer AG, Leverkusen, Germany |
| KAOLIN Hi-White | Clay | Evans Clay Company, McIntyre, GA |
| TONE 0301 | Polyol | Union Carbide, Houston, TX |
| OX-50 | Dried fumed silica | Degussa, Düsseldorf, Germany |
| SnCl₂ | Catalyst | Atofina Chemicals, Philadelphia, PA |
| PG425 | Polypropylene glycol | Bayer AG, Leverkusen, Germany |
| LUPRANATE | Carbodiimide modified | BASF Corp., Florham Park, NJ |
| MM103 | methylenebis(phenyl | |
| | isocyanate) | |

Abrasive agglomerates containing 0.25 and 0.5 micron diamond particles were generated using the method outlined in Example 1 of U.S. Pat. No. 6,645,624, except that 0.25 micron and 0.5 micron diamonds were used. Diamond-free abrasive agglomerates were prepared for Example 5. Further processing was carried out as outlined below.

The density determination was performed in a 10 milliliter container using an AccuPyc 1330 Pycnometer available from Micromeritics. The sample size was 8.5 grams for the diamond containing agglomerates and 6.5 grams for the silica agglomerates. The method of measurement uses the pressure differences observed upon filling the sample chamber with helium gas and then discharging the gas into a second chamber to compute the solid phase volume of the sample. The instrument automatically purges water and any volatiles from the sample and repeats the analysis until successive measurements converge upon a consistent result.

The reported density values were obtained by dividing the weight by the measured volume. The density of the abrasive agglomerates containing 0.5 micron diamonds was 2.555 g/cc. The density of the abrasive agglomerates containing 0.25 micron diamonds was 2.567 g/cc. The density of the diamond-free abrasive agglomerates was 2.252 g/cc.

A solution of 150 grams of isopropanol mixed with 48 grams of deionized water was prepared. Over a period of ten minutes, 2 grams of Z-6020 was added to this solution, while stirring. The pH of the solution was adjusted to 4.0 using acetic acid. While stirring, 100 grams of the desired abrasive agglomerates were added to the silane solution and the resulting suspension was allowed to stand for fifteen minutes. Using Whatman 54 filter paper, the silane treated abrasive agglomerates were captured, rinsed with deionized water, and dried in an oven for twenty-four hours at 115° C.

Abrasive agglomerate-containing premixes were made according to the compositions described in Table 3.

TABLE 3
Compositions of the abrasive agglomerate premixes.

| Ingredient | Example 1 | Example 2 | Example 3 | Example 4 |
|---|---|---|---|---|
| Poly Clay premix | 268.01 g | 264.15 g | 264.15 g | 264.15 g |
| 0.5 micron diamond | 41.64 g | 41.61 g | 50.00 g | — |
| abrasive agglomerate | | | | |
| 0.25 micron diamond | — | — | — | 41.61 g |
| abrasive agglomerate | | | | |
| Dried Fumed Silica | 2.14 g | 2.14 g | — | 2.14 g |
| (OX-50) | | | | |
| SCOTCHLITE | — | — | 13.21 g | — |
| S60/10000 | | | | |
| hollow glass spheres | | | | |
| TONE 0301 | 6.50 | 10.39 g | 10.39 g | 10.39 g |
| SnCl₂ solution | 2.75 g | 5.49 g | 5.49 g | 5.49 g |
| LUPRANATE | 49.02 g | — | — | — |
| MM103 | | | | |
| PU1 | — | 60.36 g | 60.36 g | 60.36 g |
| Methyl-ethyl ketone | 4.64 g | — | 4.64 g | — |

A dispersant solution was produced by mixing approximately 33 percent by weight (wt %) ARCOL PPG-2025, 27 wt % LHT-112, 39 wt % KAOLIN Hi-White, and less than 1 wt % each of an epoxy resin, a calcium alkanoate solution, an ultraviolet absorber, and a solvent. The dispersant solution was mixed with TONE 0301 using a PL5-5 model vacuum mixer fitted with a double planetary mixer (Premier Mill Corporation (Reading, Pa.)) without engaging the vacuum, to produce a resin premix. The desired abrasive agglomerates were added to the resin premix and mixed for ten minutes. The mixing was stopped to scrape the sides of the container vessel to incorporate any unmixed material into the mixture. An additional ten minutes of mixing was needed to produce a homogenous mixture. OX-50 was added and allowed to mix for ten minutes. When the mixture was homogenous, the vacuum was engaged and mixing continued under vacuum for ten minutes.

Prior to coating, a polyol prepolymer and a 20% solution of SnCl₂ in PG425 at a level of 2% SnCl₂ on the polyol were added to the mixture with good mixing to produce the final coating slurry. The abrasive article was formed by coating the slurry described above onto a 50 micron (2 mil) thick primed polyethylene film using a mechanized knife coater to produce a dried caliper of 1 millimeter. The line speed was set at 0.61 meters/minute (2 feet/minute) to provide a total of nine minutes exposure of the abrasive article to 95° C. in the associated oven. Further curing of the abrasive article was carried out with a post cure step involving storage at 80° C. for twenty-four hours.

### EXAMPLE 1-4

Flexible fixed abrasive articles were produced according to the method described previously. In Example 1, the polyol prepolymer was LUPRANATE MM 103. In Examples 2-4, the polyol prepolymer was a toluene diisocyanate (TDI) terminated prepolymer of TDI and propylene oxide adducts of propanediol and propanetriol. Cut rates were measured according to Test Method A, and are reported in Table 4.

TABLE 4
Cut rates for Examples 1–4

| | Cut Rate (grams/min) | | | |
|---|---|---|---|---|
| Run Number | Example 1 | Example 2 | Example 3 | Example 4 |
| 1 | 1.69 | 4.18 | 5.47 | 3.59 |
| 2 | 2.04 | 4.42 | 6.01 | 3.58 |
| 3 | 1.83 | 4.29 | 6.45 | 2.54 |
| 4 | 2.09 | 4.50 | 6.80 | 2.83 |
| 5 | 1.63 | 4.01 | 6.93 | 2.95 |
| 6 | 1.46 | 4.45 | 5.53 | 3.08 |
| 7 | 1.63 | 4.22 | 6.03 | 2.99 |
| 8 | 1.95 | 4.62 | 6.09 | 2.93 |
| 9 | 2.27 | 4.17 | 5.11 | 3.31 |
| 10 | 2.13 | 4.84 | 5.22 | 3.27 |
| 11 | 1.61 | 4.14 | 5.33 | 3.19 |
| 12 | 1.62 | 4.67 | 5.83 | 3.77 |
| 13 | 1.57 | 4.39 | 5.93 | 3.60 |

The percent compression (PC) and compression set (CS) were measured according to test Method B. The average values and standard deviations are reported in Table 5.

TABLE 5
Percent Compression and Compression Set

| | Example 1 | | Example 2 | | Example 3 | |
|---|---|---|---|---|---|---|
| | PC (%) | CS (%) | PC (%) | CS (%) | PC (%) | CS (%) |
| Average | 4 | 25 | 3.1 | 6 | 3 | 1 |
| Std. Dev. | 2 | 6 | 0.6 | 6 | 1 | 5 |

### EXAMPLE 5

A flexible abrasive article was prepared as in Example 2 except that diamond-free abrasive agglomerates were used instead of the 0.5 micron diamond abrasive agglomerates. The 200 mm wafers from Example 4 were used for edge cleaning experiments using the method outlined in Test Method A except the time was reduced to 30 seconds. Visual inspection of wafers under a microscope was performed before and after cleaning. Wafer edges were glossier and little debris was observed after cleaning.

For Examples 1-5, the compression modulus was measured according to Test Method C, and is reported in Table 6.

TABLE 6
Compression Modulus (GPa)

| | Ex. 1 | Ex. 2 | Ex. 3 | Ex. 4 | Ex. 5 |
|---|---|---|---|---|---|
| Average | 55 | 40 | 70 | 39 | 7 |
| Std. Dev. | 3 | 2 | 6 | 2 | 0.4 |

Various modifications and alterations of this invention will become apparent to those skilled in the art without departing from the scope and spirit of this invention.

What is claimed is:

1. An abrasive article comprising a compressible composite layer, wherein the compressible composite layer comprises a compressible binder and about 2% to about 10% by volume abrasive agglomerates; and wherein the compressible composite layer has a compression modulus of about 7 to about 70 GPa over a range of about 2.5% to about 5.5% compression.

2. The abrasive article of claim 1, wherein the compressible composite layer comprises about 2.5% to about 3% by volume of the abrasive agglomerates.

3. The abrasive article of claim 1, wherein the compressible composite layer has a compression modulus of about 35 to about 50 GPa over the range of about 2.5% to about 5.5% compression.

4. The abrasive article of claim 1, wherein the abrasive agglomerates have a density of about 2.45 to about 2.75 grams per cubic centimeter.

5. The abrasive article of claim 1, wherein the abrasive agglomerates have a density of about 2.15 to about 2.35 grams per cubic centimeter.

6. The abrasive article of claim 1, wherein the compressible binder has a compression modulus of about 10 to about 30 GPa over the range of about 2.5% to about 5.5% compression.

7. The abrasive article of claim 1, wherein the compressible composite layer comprises at least 50% by volume of the compressible binder.

8. The abrasive article of claim 1, wherein the compressible binder comprises a material selected from the group consisting of urethanes, polyether urethanes, polyester urethanes, epoxies, and combinations thereof.

9. The abrasive article of claim 1, wherein the compressible composite layer further comprises an inorganic filler.

10. The abrasive article of claim 1, wherein the abrasive agglomerates comprise diamond abrasive particles dispersed in an inorganic matrix.

11. The abrasive article of claim 10, wherein the inorganic matrix is selected from the group consisting of glass, ceramic, and glass ceramic.

12. The abrasive article of claim 10, wherein the inorganic matrix comprises silica.

13. The abrasive article of claim 10, wherein the average maximum cross-sectional dimension of the diamond abrasive particles is less than about 2 microns.

14. The abrasive article of claim 13, wherein the average maximum cross-sectional dimension of the diamond abrasive particles is less than about 0.5 microns.

15. The abrasive article of claim 10, wherein the abrasive agglomerates comprise about 25% to 50% by weight diamond abrasive particles.

16. The abrasive article of claim 1, wherein the abrasive agglomerates comprise silica agglomerates.

17. The abrasive article of claim 16, wherein the silica agglomerates comprise at least about 95% by weight silica.

18. The abrasive article of claim 16, wherein the abrasive agglomerates further comprise about 0.1% to about 50% by weight alumina abrasive particles.

19. The abrasive article of claim 1, further comprising a support adjacent the compressible composite layer.

20. The abrasive article of claim 19, wherein the compressible composite layer comprises a first major surface and a second major surface, and wherein the first major surface of the compressible composite layer is directly bonded to the support.

21. The abrasive article of claim 19, wherein the composite layer comprises a first major surface and a second major surface, and wherein a bonding layer is interposed between the first major surface of the compressible composite layer and the support.

22. The abrasive article of claim 19, wherein the support is a rigid cylinder, a rigid ring, a rigid planar body, a continuous belt or a flexible web.

23. The abrasive article of claim 1, wherein the compressible composite layer has a compression set of less than about 50% as measured 30 seconds after removal of an applied compression load sufficient to produce about 2.5% to about 5.5% compression.

24. A method of modifying an edge of a workpiece comprising:
providing an abrasive article comprising a compressible composite layer having a first major surface and a second major surface, wherein the compressible composite layer comprises a compressible binder and about 2% to about 10% by volume abrasive agglomerates; and wherein the compressible composite layer has a compression modulus of about 7 to about 70 GPa over a range of about 2.5% to about 5.5% compression;
contacting the edge of the workpiece with the second major surface of the compressible composite layer; and
providing a relative motion between the edge of the workpiece and the second major surface of the compressible composite layer.

25. The method of claim 24, wherein contacting the edge of the workpiece with the second major surface of the compressible composite layer comprises applying sufficient contact force to compress the compressible composite layer by about 2.5% to about 5.5%.

26. The method of claim 25 wherein the contact force is in the range of about 1.5 to about 8 kilograms per millimeter of thickness of the workpiece.

27. The method of claim 24, wherein the velocity of the second major surface of the compressible composite layer relative to the edge of the workpiece is between about 8 and about 16 meters per second, inclusive.

28. The method of claim 24, wherein creating a relative motion between the edge of the workpiece and the second major surface of the compressible composite layer comprises rotating the workpiece around a first axis of rotation and rotating the abrasive article around a second axis of rotation.

29. The method of claim 28, wherein the first axis of rotation forms an angle of between about 5 degrees and about 75 degrees with the second axis of rotation.

30. The method of claim 24, further comprising applying a working fluid to the second major surface of the composite layer.

31. The method of claim 24, further comprising altering a profile of the edge of workpiece.
